(19) United States
(12) Patent Application Publication
(10) Pub. No.: US 2006/0067544 A1
(43) Pub. Date: Mar. 30, 2006

(54) Method and apparatus for powering a listening device

(75) Inventor: Paul F. Moraghan, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: KNOWLES ELECTRONICS, LLC, Itasca, IL (US)

(21) Appl. No.: 10/952,983

(22) Filed: Sep. 29, 2004

(51) Int. Cl. H04R 3/00

(52) U.S. Cl. 381/113; 381/111; 381/122

(57) ABSTRACT

A device, such as a hearing aid, includes a microphone, an amplifier and a receiver (e.g., a speaker). A charge pump and voltage regulator circuit couples to a power source for the listening device. The charge pump and voltage regulator circuit generates a larger, smaller or same voltage output as compared to a nominal voltage of the power source for providing a proper operating voltage to the listening device.

### TECHNICAL FIELD

This patent generally relates to power supplies used in listening devices, such as hearing aids or the like, and more particularly, to a charge pump and voltage regulator circuit to generate an output voltage at a predetermined nominal voltage for the listening device.

### BACKGROUND

1. Technology provides many different hearing aid styles including: Behind-The-Ear (BTE), In-The-Ear or All In-The-Ear (ITE), In-The-Canal (ITC), and Completely-In-The-Canal (CIC). Advancement of this technology also provides improved audible signal reception, size, wearing-comfort, life-span, and power efficiency in listening devices such as hearing aids. The ever-increasing performance demands of these ear-worn acoustic devices, however, place ever-increasing demands on the size, performance, cost and efficiency of the circuits and transducers used within the devices. For hearing aids and other types of assistive listening devices, these circuits and transducers may include a microphone, a preamplifier, a voltage regulator, a power amplifier, a receiver (e.g., a speaker) and a power source (e.g., a battery).

The microphone receives vibration energy, i.e. acoustic sound waves, and generates an electronic signal representative of these sound waves. The preamplifier is coupled to the microphone to receive the electronic signal, modify the electronic signal, and communicate the modified electronic signal (e.g. the processed signal) to the power amplifier. The receiver assembly driven by the power amplifier converts the modified electronic signal into vibration energy for transmission to a listener.

To produce amplified sound in the user's ear, the power source supplies power to both the preamplifier and the power amplifier. While the power source is typically a battery with a nominal voltage of approximately 1.3 volts (V), the circuits and transducers often require an operating voltage different than the battery voltage. Moreover, draining of energy from the battery and varying load demands of the circuits and transducers placed on the battery may cause the power supply voltage to fluctuate.

Power supply voltage fluctuation may result in undesirable distortion, system instability or both. Power supply fluctuation can be smoothed or substantially eliminated and a generally uniform 0.9V supplied to the circuits and transducers using a voltage regulator. The voltage regulator provides a predetermined, substantially ripple-free voltage from the power source to the various circuits and transducers in the listening device. However, the voltage regulator does not generate a voltage output larger than the source nominal voltage.

Available substantially uniform power at voltage levels above or below the source nominal voltage is desirable within a listening device; however, at the same time, that power should be provided without substantially adding to size and cost of the listening device.

### BRIEF DESCRIPTION OF THE DRAWINGS

For a more complete understanding of the disclosure, reference should be made to the following detailed description and accompanying drawings wherein:

FIG. 1 is a exploded assembly view of a microphone;

FIG. 2 is a schematic block diagram of a listening device in accordance with the described embodiments of the invention;

FIG. 3 is a simplified diagram of a charge pump and voltage regulator circuit in accordance with the described embodiments; and

FIG. 4 a schematic diagram of a charge pump circuit that may be used in the charge pump and voltage regulator circuit illustrated in FIG. 3.

### DETAILED DESCRIPTION

While the invention described by the claims of this patent is susceptible to various modifications and alternative forms, the figures and the following discussion illustrate and describe several embodiments of the invention. It will be understood, however, that this disclosure is not intended to limit the invention to the particular forms described, but to the contrary, the invention is intended to cover all modifications, alternatives, and equivalents falling within the spirit and scope of the invention defined by the appended claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity so as not to confuse the reader, and it is not intended that such claim term be limited, by implication or otherwise, to that single meaning. Unless a claim element is defined by reciting the word “means” and a function without the recital of any structure, it is not intended that the scope of any claim element be interpreted based on the application of 35 U.S.C. §112, sixth paragraph.

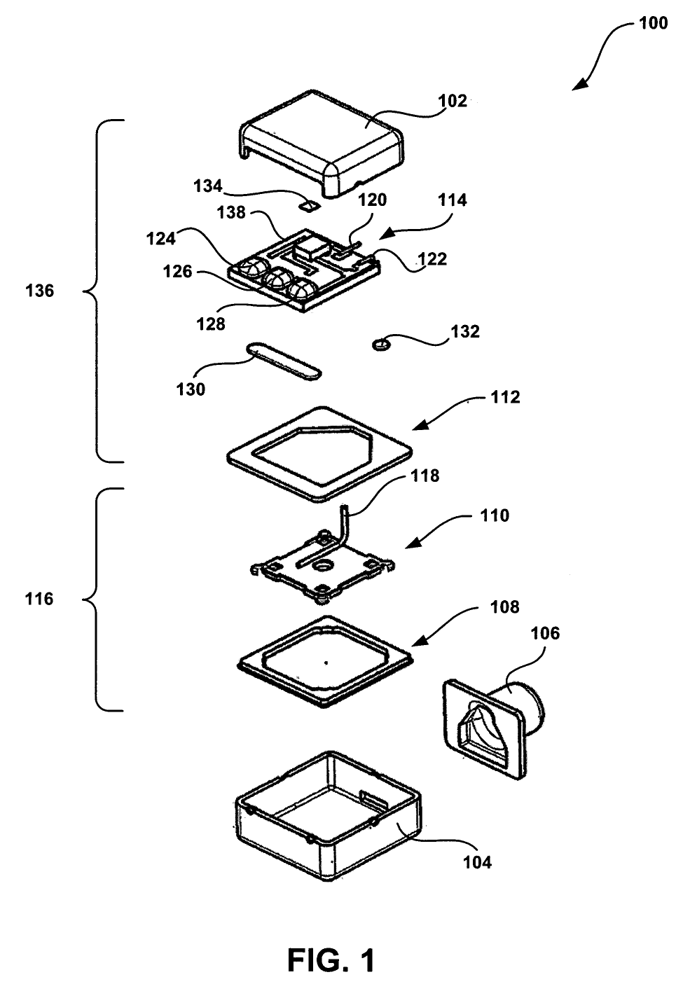

Referring to FIG. 1, an enlarged exploded view of a microphone assembly 100 is shown. The microphone 100 including a cover 102, a cup or base 104, a sound inlet port 106, a diaphragm 108, a backplate 110, a mounting frame 112, and a CMOS preamplifier 114. The backplate 110 mounted to the diaphragm 108 is positioned within the base 104. The resulting combination of the backplate 110 and the diaphragm 108 constitute an electret microphone portion 116 to generate a representative electrical signal corresponding to movement of the diaphragm 108 relative to the backplate 110 when exposed to acoustic waves or sonic energy.

A connecting wire 118 extending through an opening formed in the mounting frame 112 electrically couples the backplate 110 to an input 120 of the preamplifier 114. Ground mounting point 122 grounds the preamplifier 114 to the diaphragm 108, the mounting frame 112 and the base 104. The preamplifier 114 may include a plurality of electrical connection terminals such as an input terminal 124, an output terminal 126, and a ground terminal 128. The input terminal 124 supplies electrical power to the preamplifier assembly 114. The input terminal 124 and the output terminal 126 may further be coupled to other electronic circuits (not shown). The ground terminal 128 connects to the ground point 122 to reduce the sensitivity to low and high radio frequency interference (RFI) signals generated by communications devices such as, for example, cellular phones.

Conductive adhesives 130, 132 advantageously couple the preamplifier assembly 114 to the base 104 via the mounting frame 112 also to reduce or eliminate RFI at the output terminal 126. Wire bonding 134 further grounds the preamplifier assembly 114 to the cover 102. Suitable conductive adhesives are well known and may include epoxy with suspended metallic flakes such as a two-part silver epoxy adhesive. Alternatively, laser or spot welding may provide the ground coupling connections. The mounting frame 112 and the preamplifier 114 are disposed within a back volume 136 defined by the cover 102.

The preamplifier 114 may include an impedance buffer circuit 138 such as a source-follower field effect transistor (FET) integrated circuit adapted to reduce RFI. The preamplifier assembly 114 can further include a first resistance-capacitance network (not shown) and a second resistance-capacitance network (not shown) communicatively connected to the impedance buffer circuit 138 as disclosed in U.S. patent application Ser. No. 10/809,894, entitled “Microphone Assembly with Preamplifier and Manufacturing Method Thereof”, filed on Mar. 26, 2004, the disclosure of which is hereby incorporated by reference in its entirety for all purposes, to suppress undesirable RFI generated by nearby electronic devices.

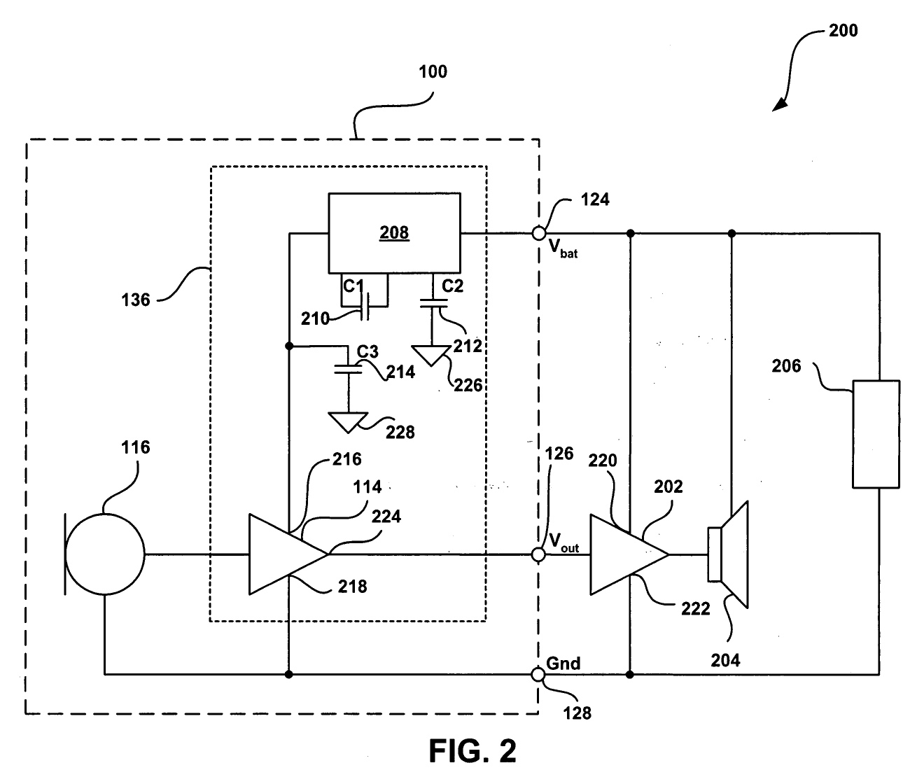

FIG. 2 illustrates a schematic block diagram of a listening device 200 such as a hearing aid. The device 200 includes a microphone 100, an output amplifier 202, a receiver (speaker) 204, and a power source 206 such as a battery. The power source 206 may provide a nominal voltage of about 1.5V.

The microphone 100 may include the foregoing described microphone portion 116. In such an embodiment, the microphone 100 includes the power terminal (V_{BAT}) 124, the signal output terminal (V_{OUT}) 126, and the ground terminal (GND) 128. The power source 206 electrically couples to the terminals 124 and 128. A charge pump and voltage regulator circuit 208, a transfer capacitor (C1) 210, and a reservoir capacitor (C2) 212 couple the power source 206 to the preamplifier 114. The microphone portion 116 receives acoustic sound waves and generates an electronic signal representative of these sound waves. The microphone portion 116 generates an output signal that is coupled to the signal input of the preamplifier 114.

The output 224 of the preamplifier 114 is coupled to the output amplifier 202 via V_{OUT} 126. The output amplifier 202 drives the receiver 204 to a required power level so that the receiver 204 produces acoustic signals at a level sufficient to compensate for the user's hearing loss.

The output amplifier 202 may be a power amplifier that includes first and second power connections 220, 222. An output of the power amplifier 202 drives the receiver 204. The first and second power connections 220, 222 couple to the positive and negative terminals of the power source 206, respectively. The receiver 204 also couples to the positive terminal of the power source 206. The receiver 204 generates an output acoustic signal responsive to the modified electronic signal.

The preamplifier 114 may be a filter, a source-follower field effect transistor (FET), a source-follower complimentary metal-oxide field effect transistor (CMOS FET), a signal processing circuitry, or an A/D converter for conversion of the analog signal from the microphone portion 116 into digital form. The preamplifier 114 includes first and second power connections 216, 218. The second power connection 218 and the microphone portion 116 both electrically couple to the negative terminal of the power source 206 via GND 128. A capacitor (C3) 214 couples the output of the charge pump and voltage regulator circuit 208 to ground terminal 228 before the first connection 216 of the preamplifier 114 to filter the regulated voltage, i.e. suppress noise and minimize voltage fluctuation.

The charge pump and voltage regulator circuit 208 is configured to generate larger or smaller output voltage depending on the value of the power source 206 and the required operating voltage of the preamplifier 114 and further to stabilize the output voltage required by the working components of the hearing aid. The preamplifier 114 first power connection 216 couples to the power source 206 via the charge pump and voltage regulator circuit 208. The charge pump and voltage regulator circuit 208 may be integrated on a single integrated circuit (IC) chip. Alternatively, the charge pump and voltage regulator circuit 208 may be integrated onto a common chip with the preamplifier 114.

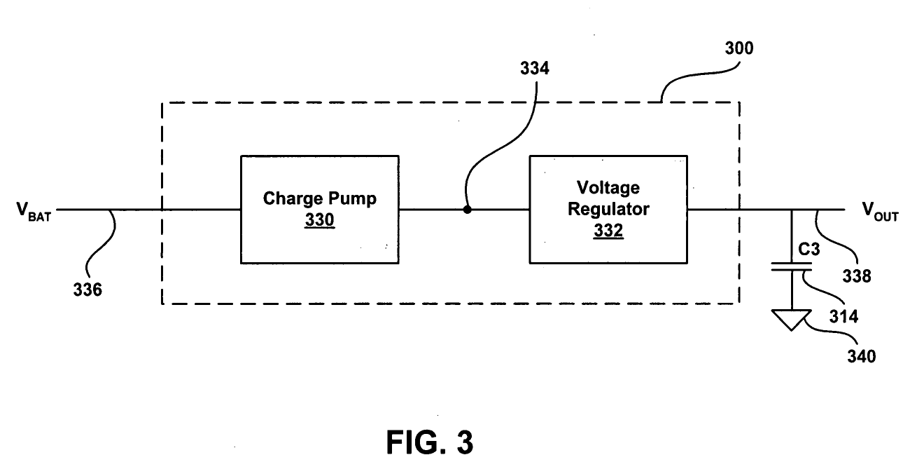

FIG. 3 illustrates a simplified diagram of a charge pump and voltage regulator circuit 300. In this embodiment, a charge pump 330 and a voltage regulator 332 coupled to the charge pump 330 at a node 334 are both integrated in a single IC chip. The circuit 300 includes a power terminal 336 to couple to a power source, e.g., to V_{BAT}, and a voltage output terminal 338 to provide V_{OUT}. A capacitor (C3) 314, provided either on-chip or off-chip and shown off-chip in FIG. 3, couples from the output terminal 338 and ground terminal 340 to filter or reduce noise and minor fluctuations in the voltage output, V_{OUT}. The voltage regulator 332 coupled to the charge pump 330 at the node 334 maintains the circuit 300 output voltage at a predetermined value.

In one embodiment of the listening device 200 illustrated in FIG. 2, the circuit 300 is used as the charge pump and voltage regulator circuit 208. The power terminal 336 couples to the positive terminal of the battery 206 via V_{BAT} 124 and the output terminal 338, i.e., V_{OUT} 126, couples to the first power connection 216 of the preamplifier 114. In this particular embodiment, the charge pump and voltage regulator circuit 208 is configured to produce a voltage output that is greater than a nominal voltage Of V_{BAT} 124.

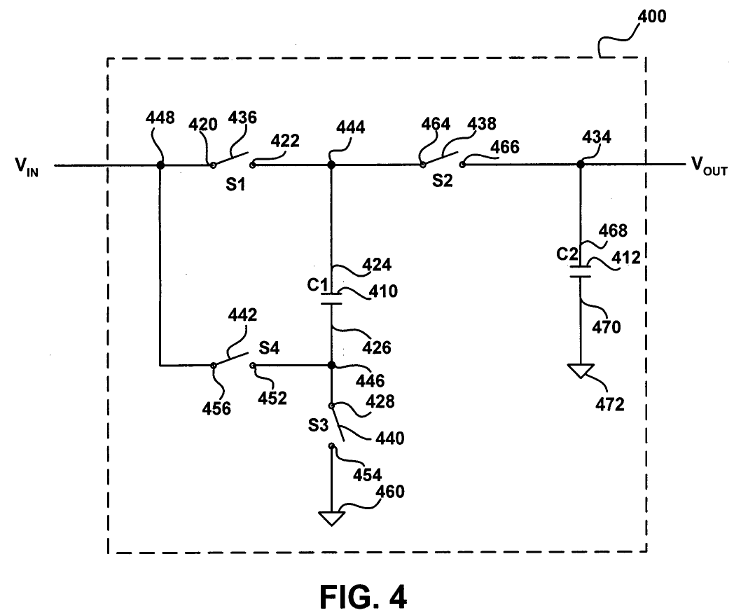

FIG. 4 illustrates a schematic diagram of a charge pump circuit 400 that may be used as the charge pump 330 in FIG. 3. A first terminal 420 of a first switch (S1) 436 connects to the positive terminal of a power source. A second terminal 422 of the switch S1 436 connects to a first terminal 424 of a transfer capacitor (C1) 410 at a node 444. A second terminal 426 of the capacitor C1 410 connects to a first terminal 428 of a third switch (S3) 440 and a first terminal 452 of a fourth switch (S4) 442 at a node 446. A second terminal 454 of the switch S3 440 is connected to a reference ground terminal 460. A second terminal 456 of the switch S4 442 connects back to the first terminal 420 of the switch S1 436 at a node 448. A first terminal 464 of a second switch (S2) 438 is connected at node 444 and a second terminal 466 of the switch S2 438 is connected to both the node 434 and a first terminal 468 of a reservoir capacitor (C2) 412. The second terminal 470 of the capacitor C2 412 connects to a ground terminal 472. The switches 436, 438, 440, and 442 may be controlled by a clock and a digital logic circuit (not depicted) or other suitable control circuitry as is well known in the art. In a first phase, the capacitor C1 410 charges to the voltage Vᵢₙ via the switch S1 436 and the switch S3 440 which are closed while the switch S2 438 and the switch S4 442 remain open. During a second phase, the switch S1 436 and the switch S3 440 are open and the switch S2 438 and the switch S4 442 are closed. The power source (not depicted in FIG. 4) is then effectively placed in series with the voltage stored across the capacitor C1 410. Thus the sum of the voltage across the power source and the capacitor C1 410 is placed across the capacitor C2 412. The first and second phases of the circuit operation described above are repeated continuously during normal circuit operation.

A device built in accordance with the embodiment illustrated in FIG. 2 has the advantages of reduced cost, reduced layout time and application of the proper operating voltage either above or below that of the power source to the preamplifier 114.

All references, including publications, patent applications, and patents, cited herein are hereby incorporated by reference to the same extend as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided herein, is intended merely to better illuminate the invention; and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A device comprising:
a microphone having an acoustic input and a microphone output, an amplifier having a signal input coupled to the microphone output and an amplifier output;
a receiver having an input coupled to the amplifier output and an acoustic output;
a power source; and
a charge pump circuit coupling the power source to at least one of the amplifier, the microphone and the receiver.

2. The device of claim 1, a voltage regulator coupled to an output of the charge pump.

3. The device of claim 2, wherein the charge pump and voltage regulator are integrated on an integrated circuit (IC) chip.

4. The device of claim 2, an output of the coupled voltage regulator and charge pump being at least one of greater than the source voltage, less than the source voltage and equal to the source voltage.

5. The device of claim 1 being incorporated into a hearing aid.

6. The device of claim 1, comprising a preamplifier coupled between the microphone and the amplifier, the charge pump circuit coupling the power source to the preamplifier.

7. The device of claim 1, comprising circuitry coupled to the charge pump to minimize electrical noise and voltage output fluctuations.

8. The device of claim 7, the circuitry comprising a capacitor coupled between an output of the charge pump and ground.

9. The device of claim 1, the microphone comprising a microphone housing, the charge pump being disposed within the microphone housing.

10. A method of powering a device, the device comprising a microphone having an acoustic input and a microphone output; an amplifier having a signal input coupled to the microphone output and an amplifier output; a receiver having an input coupled to the amplifier output and an acoustic output; and a power source, the method comprising: coupling a charge pump circuit between the power source and at least one of the preamplifier, the amplifier, the microphone, and the receiver.

11. The method of claim 10, further comprising coupling a voltage regulator to an output of the charge pump.

12. The method of claim 11, comprising integrating the charge pump and voltage regulator on an integrated circuit chip.

13. The method of claim 11, comprising providing from the coupled charge pump and voltage regulator an output voltage that is greater than, less than or equal to an output voltage of the power source.

14. The method of claim 10, comprising disposing the charge pump within a housing for the microphone.

15. The method of claim 10, comprising optionally suppressing noise and voltage fluctuations in an output of the charge pump.

16. The method of claim 10, wherein a preamplifier is disposed between the microphone and the amplifier, the method comprising coupling the charge pump to the preamplifier.

17. A hearing aid comprising:
a microphone having an acoustic input and a microphone output, an amplifier having a signal input coupled to the microphone output and an amplifier output;
a receiver having an input coupled to the amplifier output and an acoustic output;
a power source; and
a charge pump circuit coupling the power source to at least one of the amplifier, the microphone and the receiver.

18. The hearing aid of claim 17, a voltage regulator coupled to an output of the charge pump.

19. The hearing aid of claim 18, an output of the coupled voltage regulator and charge pump being at least one of greater than the source voltage, less than the source voltage and equal to the source voltage.

20. The hearing aid of claim 18, comprising a preamplifier coupled between the microphone and the amplifier, the charge pump circuit coupling the power source to the preamplifier.

21. The hearing aid of claim 17, comprising circuitry coupled to the charge pump to minimize electrical noise and voltage output fluctuations.
